(19) United States
(12) Patent Application Publication
(10) Pub. No.: US 2010/0026018 A1
(43) Pub. Date: Feb. 4, 2010

(54) Lock knob for lock rod in motor vehicle

(75) Inventors: Charles Daniel Bailey, Shelby Twp., MI (US); Michael Cass, Lenox, MI (US); Jeffrey Allen Borchers, Waterford, MI (US); Don Stacherski, Rochester Hills, MI (US); Thomas Franz Josef Gehring, Toronto (CA)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: International Automotive Components Group North America, Inc.

(21) Appl. No.: 12/221,167

(22) Filed: Jul. 31, 2008

(51) Int. Cl. E05B 1/00

(52) U.S. Cl. 292/347

(57) ABSTRACT

A lock knob for covering an end of a lock rod protruding through a door of a motor vehicle is disclosed herein. The lock knob includes a first knob portion. The lock knob also includes a second knob portion. The lock knob also includes a multi-stage locking structure operable to engage the first knob portion and the second knob portion together in a first configuration. When the first and second knob portions are in the first configuration, the end of the lock rod can be slidably received between the first knob portion and the second knob portion. The multi-stage locking structure is also operable to engage the first knob portion and the second knob portion together in a second configuration. When the first and second knob portions are in the second configuration, the lock rod is fixed relative to the first knob portion and to the second knob portion.

### BACKGROUND OF THE INVENTION

This invention relates in general to a lock knob for covering an end of a lock rod protruding through a door of a motor vehicle. Figure shows a lock knob 10 according to the prior art. A first knob portion 12 includes a sleeve portion 14 for receiving an end of the lock rod (not shown). The first knob portion 12 engages a second knob portion 16 to define a cavity enclosing the end of the lock rod. The second lock portion 16 defines a window 18. The first and second knob portions 12, 16 are abutted against one another and a portion of the lock rod will be exposed in the window 18. The position of the combined first and second knob portions 12, 16 must be adjusted so that the a threaded portion of the lock rod will be exposed in the window 18. After this adjustment, a third knob portion 20 is inserted into the window 18. The third knob portion 20 includes a downwardly-facing threaded surface that engages the threaded portion of the lock rod. The third knob portion 20 will thus lock onto the threaded portion of the lock rod and will also lock the first and second knob portions 12, 16 together.

### SUMMARY OF THE INVENTION

In summary, the invention is a lock knob for covering an end of a lock rod protruding through a door of a motor vehicle. The lock knob includes a first knob portion. The lock knob also includes a second knob portion. The lock knob also includes a multi-stage locking structure operable to engage the first knob portion and the second knob portion together in a first configuration. When the first and second knob portions are in the first configuration, the end of the lock rod can be slidably received between the first knob portion and the second knob portion. The multi-stage locking structure is also operable to engage the first knob portion and the second knob portion together in a second configuration. When the first and second knob portions are in the second configuration, the lock rod is fixed relative to the first knob portion and to the second knob portion.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is an exploded view of a lock knob according to the prior art;

FIG. 2 is an exploded view of a lock knob according to the exemplary embodiment of the invention;

FIG. 3 is a cross-section of a first assembly view of the exemplary lock knob;

FIG. 4 is a cross-section of a second assembly view of the exemplary lock knob;

FIG. 5 is a cross-section of a final assembly view of the exemplary lock knob;

FIG. 6 is a perspective view of the exemplary lock knob with half of the lock knob cut-away; and

FIG. 7 is a front view of the exemplary lock knob in final assembly.

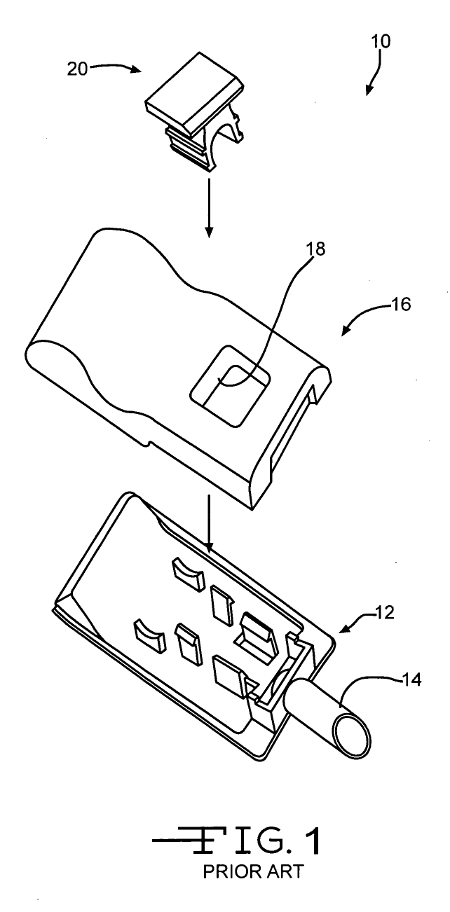

### DETAILED DESCRIPTION OF THE PREFERRED EMBODIMENT

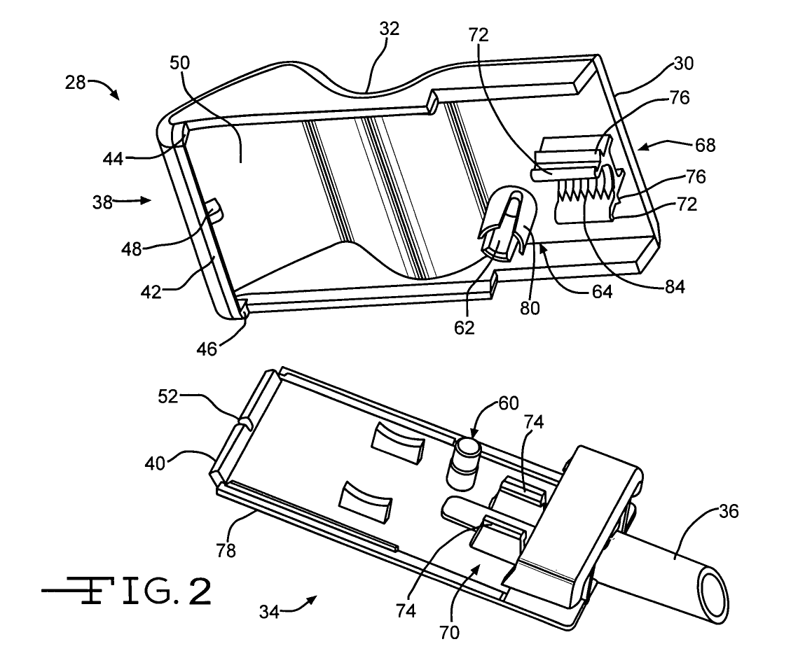

Referring now to the drawings, there is illustrated in FIG. 2 a lock knob 22 according to the exemplary embodiment of the invention. The lock knob 22 can cover an end 24 of a lock rod 26 shown in FIG. 7 protruding through a door of a motor vehicle. The lock knob 22 includes a first knob portion 28. The first knob portion 28 can be formed from plastic or any material sufficiently rigid to withstand repeated grasping and pulling, as can occur in the motor vehicle. The first knob portion 28 can include an outer surface 30 exposed to the passenger compartment of the motor vehicle and graspable by an occupant of the motor vehicle. The first knob portion 28 can be shaped with a recess 32 projecting away from the passenger compartment to ease grasping.

The lock knob 22 also includes a second knob portion 34. The second knob portion 34 can be formed from plastic or any material sufficiently rigid to withstand the forces a lock knob is subjected to during use in the motor vehicle. The second knob portion 34 can include a sleeve 36 for receiving the lock rod 26. In the exemplary embodiment of the invention, the second knob portion 34 is not visible in the passenger compartment, but could be in alternative embodiments of the invention.

The first and second knob portions 28, 34 can be assembled together for pivoting movement relative to one another. The first knob portion 28 can include an integrally-formed hook 38 and the second knob portion 34 can include an integrally-formed lip 40. The hook 38 can include a transverse wall 42 and first and second side walls 44,46. The lip 40 can be received adjacent to the transverse wall 42 and between the first and second side walls 44,46. To further solidify the connection between the hook 38 and the lip 40, a projection 48 can extend from an interior surface 50 of the first knob portion 28 and be received in a notch 52 defined in the lip 40.

The structures set forth above could be disposed in opposite manner; for example, in alternative embodiments of the invention, the lip 40 could be integral with the first knob portion 28. Alternatively, the structures need not be integral for practicing the broader invention. Furthermore, the exemplary first and second knob portions 28, 34 are discrete, separately-formed structures. However, in alternative embodiments of the invention, the first and second knob portions 28, 34 could be integrally-formed with a living hinge replacing or supplementing the hook 38 and lip 40.

The exemplary hook 38 and the lip 40 can cooperate to define a hinge connection between the first and second knob portions 28, 34. When coupled through the hook 38 and lip 40, the first and second knob portions 28, 34 can pivot relative to one another about a hinge axis 54, seen generally coming out of the page in FIG. 3. Continuing to reference FIG. 3, the first knob portion 28 can rotate about the hinge axis 54 in a direction represented by arrow 56, toward the second knob portion 34. The interaction and cooperation between the hook 38 and lip 40 can substantially prevent relative rotation between the first knob portion 28 and the second knob portion 34 along an axis 58 that is perpendicular to the hinge axis 54.

Now referencing FIGS. 2 and 3, the first knob portion 28 can rotate about the hinge axis 54 in the direction represented by arrow 56 from the position shown in FIG. 3 a predetermined radial distance and then a post 60 integrally-formed with the second knob portion 34 can be received in an aperture 62 defined by a turret 64 integrally-formed with the first knob portion 28. The interaction and cooperation between the post 60 and the turret 64 can prevent lateral relative movement between the first knob portion 28 and the second knob portion 34. During assembly, the interaction and cooperation between the hook 38 and lip 40 can provide an initial connection between the first and second knob portions 28, 34 and the interaction and cooperation between the post 60 and the turret 64 can make the connection more robust.

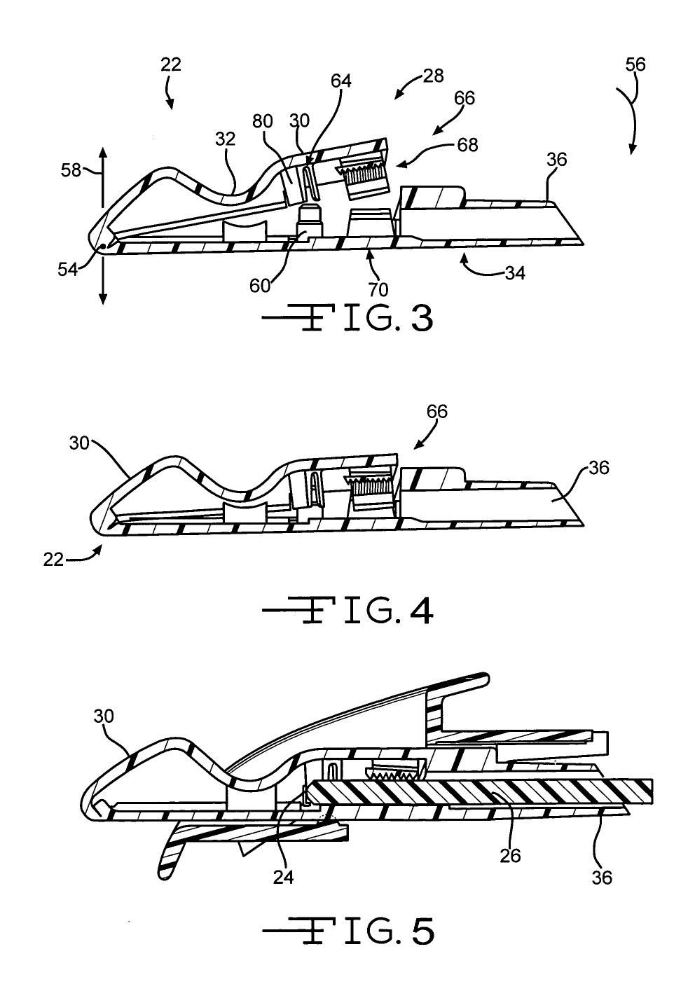

With reference to FIGS. 3-5, the lock knob 22 also includes a multi-stage locking structure 66 operable to engage the first knob portion 28 and the second knob portion 34 together in a first configuration. The first configuration is shown in FIG. 4. After the post 60 has been received in the turret 64, the first knob portion 28 can be rotated further in the direction represented by arrow 56 until a first stage of the multi-stage locking structure 66 is engaged.

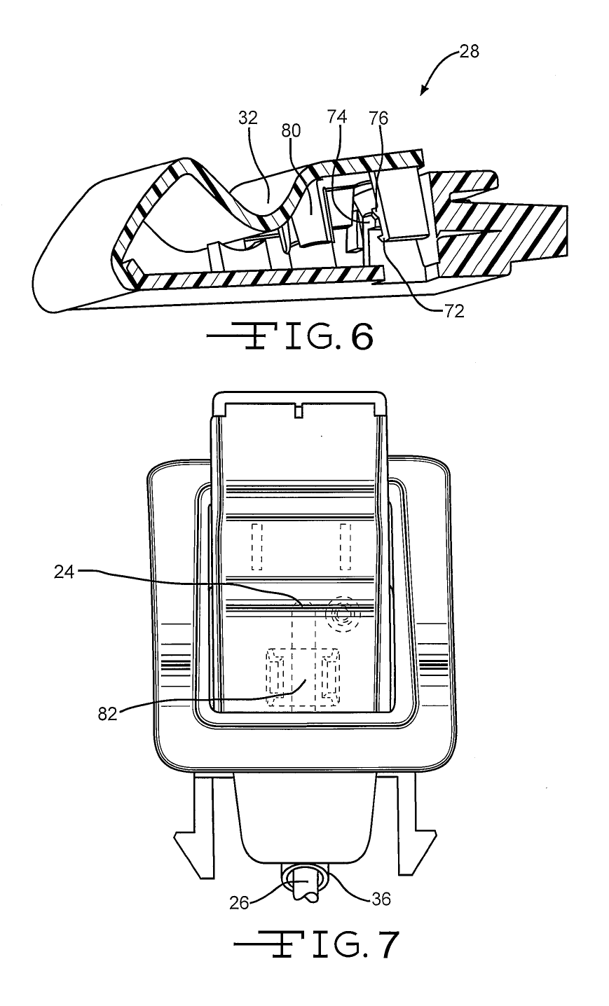

With reference to FIGS. 2, 3 and 6, the exemplary multi-stage locking structure 66 includes a first locking portion 68 integrally formed with the first knob portion 28 and a second locking portion 70 integrally formed with the second knob portion 34. The exemplary first locking portion 68 includes a pair of first detents 72. The exemplary second locking portion 70 includes a pair of second detents 74. The first and second detents 72, 74 engage one another when the first knob portion 28 and the second knob portion 34 are in the first configuration. The first configuration of the first and second knob portions 28, 34 corresponds to the first stage of the multi-stage locking structure 66.

The multi-stage locking structure 66 is also operable to engage the first knob portion 28 and the second knob portion 34 together in a second configuration. The second configuration is shown in FIG. 5. The exemplary first locking portion 68 further includes a pair of third detents 76. The second and third detents 74, 76 are engaged with one another when the first knob portion 28 and the second knob portion 34 are in the second configuration. The second configuration of the first and second knob portions 28, 34 corresponds to a second stage of the multi-stage locking structure 66. The first and second detents 72, 74 are spaced from one another when the first knob portion 28 and the second knob portion 34 are in the second configuration, but the first and second locking portion 70s contact one another when the first and second knob portions 28, 34 are in both the first configuration and the second configuration.

The exemplary third detents 76 are larger than the first detents 72. This can be desirable in the exemplary embodiment of the invention because the first stage of the multi-stage locking structure 66 is generally intended to keep the first and second knob portions 28, 34 together for transport, whereas the second stage is generally intended to keep the first and second knob portions 28, 34 rigidly together to enhance the perception of quality by the occupant of the motor vehicle.

As evident from the drawings and the description above, the multi-stage locking structure 66 is spaced from the hinge connection. In addition, the first and second configurations are defined by a proximity of the first knob portion 28 and the second knob portion 34 along an arcuate path extending about the hinge axis 54. The post 60 is received in the turret 64 when the first and second knob portions 28, 34 are in both the first configuration and the second configuration. The cooperation between the post 60 and the turret 64 can ensure that the detents 72, 74, 76 properly engage one another.

The first knob portion 28 and the second knob portion 34 cooperate to define a cavity in the first configuration between the interior surface 50 of the first knob portion 28 and an interior surface 78 of the second knob portion 34. The turret 64 defines a protrusion that extends into the cavity. The turret 64 includes an outer surface that can act as an engaging surface 80, limiting movement of the distal end 24 of the lock rod 26 into the cavity. The exemplary engaging surface 80 is discontinuous, but could be continuous in alternative embodiments of the invention. The lock rod 26 can be moved into the cavity until the end 24 or the side of the lock rod 26 abuts the surface 80.

The exemplary lock rod 26 can include an outer surface portion 82 for engagement with the lock knob 22. The exemplary outer surface portion 82 can be unevenly shaped, such as with threads or serrations or a notch. One of the first knob portion 28 and the second knob portion 34 can define an inner surface portion 84 in the cavity that is shaped to correspond to the outer surface portion 82 of the lock rod 26. In the exemplary embodiment of the invention, the outer surface portion 82 bares threads and the inner surface portion 84 is integral with the first lock knob 28 and bares similarly sized threads. Thus, when the first knob portion 28 and the second knob portion 34 are in the second configuration, the lock rod 26 and the first knob portion 28 and the second knob portion 34 are locked together through the connection between the outer surface portion 82 and the inner surface portion 84. In alternative embodiments of the invention, the outer surface portion 82 or inner surface portion 84 could be smooth and the other surface portion could define a high coefficient of friction to keep the lock rod 26 and the first knob portion 28 and the second knob portion 34 locked together.

The distal end 24 and the outer surface portion 82 are spaced a first distance apart from one another. The engaging surface 80 of the turret/protrusion 64 and the inner surface portion 84 are also spaced the first distance apart from one another. Thus, when the lock rod 26 moves to an end limit of travel into the cavity, the outer surface portion 82 and the inner surface portion 84 are aligned and engage one another when the first and second knob portions 28, 34 are moved together, into the second configuration.

In operation, the first and second knob portions 28, 34 can be initially assembled through the hook 38 and lip 40 connection. The first and second knob portions 28, 34 can then be rotated closer together, through engagement between the post 60 and turret 64, and until the first stage of the multi-stage locking structure 66 is engaged. The combined first and second knob portions 28, 34 can then be shipped to a facility at which the door of a motor vehicle is assembled. The exemplary first and second knob portions 28, 34 will not come apart during typical shipment. When the first and second knob portions 28, 34 are in the first configuration, the end 24 of the lock rod 26 can be slidably received between the first knob portion 28 and the second knob portion 34. Thus, the combined first and second knob portions 28, 34 can be slipped over the end 24 of the lock rod 26 at the door assembly facility.

The lock rod 26 can be moved into the combined first and second knob portions 28, 34 until the end 24 or the side of the lock rod 26 abuts the engaging surface 80 of the turret 64. The first and second knob portions 28, 34 can then be pressed together, engaging the second stage of the multi-stage locking structure 66 and thus causing the first and second knob portions 28, 34 to be in the second configuration. When the first and second knob portions 28, 34 are in the second configuration, the lock rod 26 is fixed relative to the first knob portion 28 and to the second knob portion 34.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A lock knob for covering an end of a lock rod protruding through a door of a motor vehicle and comprising:
a first knob portion;
a second knob portion; and
a multi-stage locking structure operable to engage said first knob portion and said second knob portion together in a first configuration wherein the end of the lock rod can be slidably received between said first knob portion and said second knob portion and also operable to engage said first knob portion and said second knob portion together in a second configuration wherein the lock rod is fixed relative to said first knob portion and to said second knob portion.

2. The lock knob of claim 1 wherein said multi-stage locking structure further comprises:
a first locking portion integrally formed with said first knob portion; and
a second locking portion integrally formed with said second knob portion, said first and second locking portions contacting one another when said first and second knob portions are in both said first configuration and said second configuration.

3. The lock knob of claim 2 wherein:
said first locking portion includes a first detent;
said second locking portion includes a second detent, said first and second detents engaging one another when said first knob portion and said second knob portion are in said first configuration and are spaced from one another when said first knob portion and said second knob portion are in said second configuration.

4. The lock knob of claim 3 wherein said first locking portion further comprises:
a third detent, wherein said second and third detents engaged with one another when said first knob portion and said second knob portion are in said second configuration.

5. The lock knob of claim 4 wherein said third detent is larger than said first detent.

6. The lock knob of claim 1 wherein said first knob portion and said second knob portion are engaged in a hinge connection for relative pivoting movement about a hinge axis between said first configuration and said second configuration, wherein said multi-stage locking structure is spaced from said hinge connection.

7. The lock knob of claim 6 wherein said first and second configurations are defined by a proximity of said first knob portion and said second knob portion along a path extending about said hinge axis.

8. The lock knob of claim 6 further comprising:
a post integrally formed with one of said first knob portion and said second knob portion; and
a turret formed with the other of said first knob portion and said second knob portion and defining an aperture receiving said post when said first and second knob portions are in said first configuration and said second configuration.

9. The lock knob of claim 8 wherein said first knob portion and said second knob portion are operable to pivot closer to one another about said hinge axis and wherein said post is received in said turret before said first knob portion and said second knob portion are engaged together in said first configuration by said multi-stage locking structure.

10. A lock knob assembly comprising:
a lock rod having a distal end;
a first knob portion at least partially enclosing said distal end of said lock rod;
a second knob portion at least partially enclosing said distal end of said lock rod; and
a multi-stage locking structure operable to engage said first knob portion and said second knob portion together in a first configuration spaced apart to slidably receive said distal end of said lock rod and also operable to engage said first knob portion and said second knob portion together in a second configuration to fix said lock rod relative to said first knob portion and to said second knob portion.

11. The lock knob assembly of claim 10 wherein said first knob portion and said second knob portion cooperate to define a cavity in said first configuration and wherein one of said first knob portion and said second knob portion includes a protrusion extending into said cavity and having an engaging surface limiting movement of said distal end into said cavity.

12. The lock knob assembly of claim 11 wherein:
said lock rod defines an outer surface portion; and
one of said first knob portion and said second knob portion defines an inner surface portion in said cavity, said outer surface portion and said inner surface portion correspondingly shaped and engaging one another when said first knob portion and said second knob portion are in said second configuration such that said distal end is fixed relative to said cavity.

13. The lock knob assembly of claim 12 wherein said distal end and said outer surface portion are spaced a first distance apart from one another and said engaging surface of said protrusion and said inner surface portion are also spaced the first distance apart from one another.

14. The lock knob assembly of claim 1 wherein said multi-stage locking structure further comprises:
a first locking portion with a plurality of detents integrally formed with said first knob portion; and
a second locking portion with a detent integrally formed with said second knob portion, said plurality of detents of said first locking portion sequentially engaging said detent of said second locking portion as said first and second knob portions move closer together between said first configuration and said second configuration.

15. The lock knob assembly of claim 14 wherein said plurality of detents of said first locking portion vary in size.

16. The lock knob assembly of claim 10 further comprising:
a hook integrally formed with one of said first and second knob portions and spaced from said multi-stage locking structure; and
a lip integrally formed with the other of said first and second knob portions and received in said hook, said hook and said lip cooperating to define a hinge connection between said first and second knob portions.

17. The lock knob assembly of claim 16 wherein said first knob portion and said second knob portion are engaged by said hinge connection for relative pivoting movement along a path about a hinge axis between said first configuration and said second configuration.

18. A method for assembling a lock knob for an end of a lock rod protruding through a door of a motor vehicle and comprising the steps of:
engaging a first knob portion and a second knob portion together in a first configuration for relative movement in only one direction;
shaping a cavity for receiving the lock rod with surfaces integral to the first knob portion and the second knob portion that control an extent that the lock rod projects into the cavity and that are operable to lock the first knob portion and the second knob portion with the lock rod when the first knob portion and the second knob portion are moved in the first direction.

19. The method of claim 18 further comprising the step of:
forming the first knob portion and the second knob portion separately as discrete structures.

20. The method of claim 18 wherein said engaging step further comprises the steps of:
preventing lateral relative movement between the first knob portion and the second knob portion by engagement between a post slidably received in a turret, the post fixed with one of the first knob portion and the second knob portion and the turret fixed with the other of the first knob portion and the second knob portion; and
preventing relative rotation between the first knob portion and the second knob portion about the post by engagement between a hook and a lip, the hook fixed with one of the first knob portion and the second knob portion and the lip fixed with the other of the first knob portion and the second knob portion.
